(19) United States
(12) Patent Application Publication
(10) Pub. No.: US 2005/0047650 A1
(43) Pub. Date: Mar. 3, 2005

(54) Image processing apparatus, method and program

(75) Inventor: Makoto Kagaya, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/923,886

(22) Filed: Aug. 24, 2004

(30) Foreign Application Priority Data
Aug. 25, 2003 (JP) 299500/2003

(51) Int. Cl. G06K 9/00; G06K 9/40

(52) U.S. Cl. 382/162; 382/254

(57) ABSTRACT

An image analysis unit analyzes an image S0 and sets a dynamic range compression rate P0. The image analysis unit calculates saturation of each of a plurality of pixels of the image S0 and counts a pixel number of high saturation pixels of which saturation is equal to or higher than a predetermined threshold value. If the pixel number of the high saturation pixels is larger than a predetermined threshold value, a new dynamic range compression rate P1 which is lower than the set dynamic range compression rate P0 is set. A compression table creation unit creates a compression table T0 based on the dynamic range compression rates P0 and P1. A compression processing unit obtains a processed image data set S1 by compressing a dynamic range of the image S0 by using the compression table T0. An image output unit prints out the processed image data set S1.

### BACKGROUND OF THE INVENTION

1. Field of the Invention

The present invention relates to an image processing apparatus and an image processing method for compressing dynamic ranges of color images into a dynamic range of an output device such as a printer, for outputting the color images. The present invention also relates to a program for causing a computer to execute the image processing method.

2. Description of the Related Art

Conventionally, images obtained by taking photographs of subjects with photography devices such as digital cameras and images obtained by photo-electrically reading images recorded on films such as negative films and reversible films, prints or the like are reproduced at reproduction devices such as printers. When the images are reproduced at the reproduction devices, dynamic ranges of the images are compressed into dynamic ranges of the reproduction devices to prevent loss of gradation in highlights and/or shadows of the images.

As the aforementioned dynamic range compression method, a method has been proposed, wherein filtering processing is performed on an image by using a low-pass filter, an unsharp image only showing low spatial frequency structures in the image is produced, and a dynamic range is compressed using the unsharp image. Accordingly, loss of gradation in both highlights and shadows of the image is prevented while contrast in fine texture in the highlights and the shadows of the image is preserved (U.S. Pat. No. 6,101,273).

However, in the method disclosed in U.S. Pat. No. 6,101,273, dynamic range compression rates are set based on information indicating brightness of the images. Therefore, there is a problem that if the dynamic ranges of the images are compressed at the set dynamic range compression rates, high saturation colors included in the images become saturated and lost.

### SUMMARY OF THE INVENTION

In view of the foregoing circumstances, it is an object of the present invention to make it possible to compress dynamic ranges of images without saturating high saturation colors.

An image processing apparatus according to the present invention is an image processing apparatus comprising:

a dynamic range compression means for obtaining a processed image of which dynamic range has been compressed by compressing a dynamic range of a color image;
a compression rate setting means for setting a dynamic range compression rate to compress the dynamic range of the color image based on the dynamic range of the color image;
a compression rate changing means for calculating saturation of each of a plurality of pixels in the color image, counting a pixel number of high saturation pixels of which saturation is higher than a first threshold value, and if the pixel number is equal to or larger than a second threshold value, setting a new dynamic range compression rate by lowering the dynamic range compression rate set by the compression rate setting means; and
a compression table creation means for creating a compression table based on one of the dynamic range compression rate and the new dynamic range compression rate.

The term “setting the dynamic range compression rate based on the dynamic range of the color image” refers to setting the dynamic range compression rate so that the dynamic range of the color image is compressed into a dynamic range of a reproduction device such as a printer, for outputting the color image.

The term “lowering the dynamic range compression rate” refers to reducing a degree of dynamic range compression. Specifically, the set dynamic range compression rate should be lowered by a predetermined value. Alternatively, the dynamic range compression rate should be lowered more as a pixel number of high saturation pixels become larger.

In the image processing apparatus according to the present invention, the compression rate setting means may create a histogram of an image data set representing the color image, calculate a dynamic range of the color image based on the histogram, and set a dynamic range compression rate for each of an area of relatively high data values, an area of relatively low data values and/or a whole area of the image data set based on the dynamic range by using a predetermined standard value of the image data set as a standard.

An image processing method according to the present invention is an image processing method comprising the steps of:
obtaining a processed image of which dynamic range has been compressed by compressing a dynamic range of a color image;
setting a dynamic range compression rate for compressing the dynamic range of the color image based on the dynamic range of the color image;
calculating saturation of each of a plurality of pixels in the color image, counting a pixel number of high saturation pixels of which saturation is higher than a first threshold value, and if the pixel number is equal to or larger than a second threshold value, setting a new dynamic range compression rate which is lower than the dynamic range compression rate; and
creating a compression table based on one of the dynamic range compression rate and the new dynamic range compression rate.

A program for causing a computer to execute the image processing method according to the present invention may also be provided.

According to the present invention, the dynamic range compression rate for the color image is set based on the dynamic range of the color image. Then, saturation of each of a plurality of pixels in the color image is calculated and a pixel number of high saturation pixels of which saturation is higher than a first threshold value is counted. If the pixel number of the high saturation pixels is equal to or larger than a second threshold value, a new dynamic range compression rate which is lower than the set dynamic range compression rate is set. Then, a compression table is created by using the dynamic range compression rate which was before or the new dynamic range compression rate. The dynamic range of the color image is compressed by using the created compression table. Here, if the dynamic range compression rate is lowered, the degree of dynamic range compression is reduced. Accordingly, high saturation pixels included in the color image become less saturated. Therefore, according to the present invention, the dynamic range of the color image including a large number of high saturation pixels may be compressed while saturation of the high saturation pixels is prevented.

Further, a histogram of the color image is obtained. A dynamic range compression rate for each of a whole area of the image data set, an area of relatively high data values and/or an area of relatively low data values is set based on the histogram by using a predetermined standard value as a standard. Contrast only in highlights or shadows in the color image is lowered by performing the dynamic range compression processing at the set dynamic range compression rate. If contrast is low in a large area, dynamic range compression processing is not performed for the area. Accordingly, loss of gradation in highlights and shadows in the image is prevented. Further, if contrast is low in a large area of the image, the contrast in the area is not further lowered. Thus, quality of processed images obtained by compressing the dynamic range may be improved.

Note that the program of the present invention may be provided being recorded on a computer readable medium. Those who are skilled in the art would know that computer readable media are not limited to any specific type of device, and include, but are not limited to: floppy disks, CD's RAM'S, ROM's, hard disks, magnetic tapes, and internet downloads, in which computer instructions can be stored and/or transmitted. Transmission of the computer instructions through a network or through wireless transmission means is also within the scope of this invention. Additionally, computer instructions include, but are not limited to: source, object and executable code, and can be in any language including higher level languages, assembly language, and machine language.

### BRIEF DESCRIPTION OF THE DRAWINGS

FIG. 1 shows a schematic block diagram illustrating a configuration of an image processing apparatus according to an embodiment of the present invention;

FIG. 2 shows a density histogram;

FIG. 3 shows an example of a compression table for compressing a dynamic range in a shadow side;

FIG. 4 shows a flow chart of processing performed in an embodiment of the present invention;

FIG. 5 shows an example of a compression table for compressing a dynamic range in a highlight side; and

FIG. 6 shows an example of a compression table for compressing a dynamic range in the shadow side and the highlight side.

### DESCRIPTION OF THE PREFERRED EMBODIMENTS

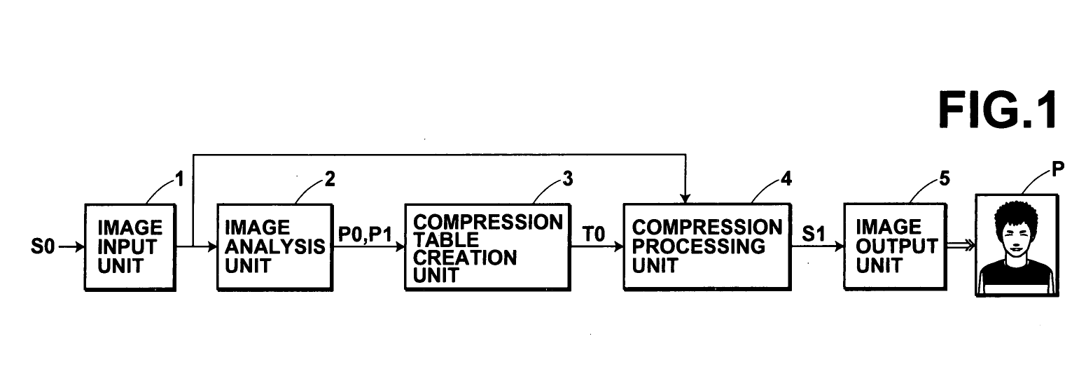

Hereinafter, embodiments of the present invention will be described with reference to drawings. FIG. 1 shows a schematic block diagram illustrating a configuration of an image processing apparatus according to an embodiment of the present invention. As illustrated in FIG. 1, the image processing apparatus in the present embodiment includes an image input unit 1 for receiving an input of an image data set S0 including each of a plurality of color components of RGB data, which represents a color image, an image analysis unit 2 (a compression rate setting means and a compression rate changing means) for setting a dynamic range compression rate by analyzing an image represented by an image data set S0 (hereinafter, reference sign S0 is also used to indicate the image), a compression table creation unit 3 for creating a compression table T0 for compressing a dynamic range of the image S0 based on the dynamic range compression rate set by the image analysis unit 2, a compression processing unit 4 for obtaining a processed image data set S1 by compressing the dynamic range of the image S0 by using the compression table T0 created by the compression table creation unit 3 and an image output unit 5 such as a printer and a monitor, for reproducing the processed image data set S1. In the present embodiment, the image output unit 5 is a printer for obtaining a print P of the processed image data set S1.

The image input unit 1 includes a media drive for reading the image data set S0 recorded on a medium from the medium and various kinds of interfaces for receiving an input of the image data set S0 sent via a network. The image data set S0 may be obtained with a photography device such as a digital camera. The image data set S0 may also be obtained by photo-electrically reading an image recorded on a film or an original copy.

The image analysis unit 2 sets a compression rate of the image S0 in the following manner. First, the image analysis unit 2 calculates a density Y of each of a plurality of pixels in the image S0 by the following expression (1). Note that R0, G0 and B0 are components of RGB data of each of the pixels in the image S0.
Y=0.3125R0+0.3750G0+0.3125B0 (1)

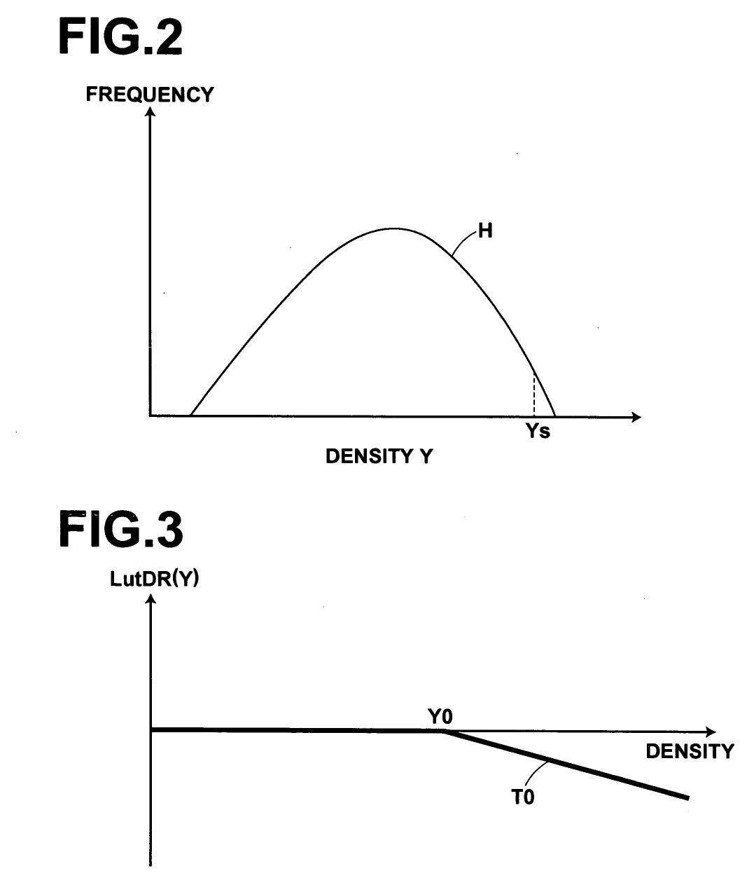

Next, the image analysis unit 2 obtains a histogram of the density Y. FIG. 2 shows a histogram H of the density Y. The image analysis unit 2 obtains a density where a cumulative relative frequency from the shadow side indicates 3% as a shadow density Ys of the image data set S0.

Meanwhile, information on a maximum density Dmax which can be reproduced by the image output unit 5 has been input to the image analysis unit 2. The image analysis unit 2 compares the shadow density Ys and the maximum density Dmax. If the shadow density Ys is higher than the maximum density Dmax, that is the shadow density Ys is darker than the maximum density Dmax, a dynamic range compression rate is calculated with respect to a predetermined standard density Y0 so that the shadow density Ys does not exceed the maximum density Dmax. Specifically, a dynamic range compression rate P0 is calculated by the following expression (2):
P0=(Ys−Y0)/(Dmax−Y0) (2).

Here, if a subject included in the image S0 is a person for example, a value of the standard density Y0 is set to a value between 0.50 and 0.70 (as a ratio to a range corresponding to a bit number), which is substantially the same as a density of a flesh color. Preferably, the value should be set to 0.6.

Next, the image analysis unit 2 calculates saturation C of each of the pixels in the image S0 by the following expression (3). Note that W in the expression (3) is (R0+G0+B0)/3, which is an average value of each of a plurality of color components R0, G0 and B0 of RGB data of each of the pixels. A calculation method of the saturation is not limited to the method shown by the expression (3) and various kinds of known methods may be used.
C=√((R0−W)²+(G0−W)²+(B0−W)²) (3)

Then, pixels of which calculated saturation C is higher than a predetermined threshold value Th1 are detected as high saturation pixels in the image S0. Further, the image analysis unit 2 counts a pixel number N of the high saturation pixels and judges whether the pixel number N is equal to or larger than a predetermined threshold value Th2. If N≧Th2, a new dynamic range compression rate P1 is set by lowering the dynamic range compression rate P0 as shown in the following expression (4):
P1=2/(1/P0+1.0) (4).

The compression table creation unit 3 creates a compression table based on the dynamic range compression rates P0 and P1 set by the image analysis unit 2. FIG. 3 shows an example of the compression table. In the compression table T0 illustrated in FIG. 3, Y0 is the aforementioned standard density and a gradient of a straight line is 1/P0 (or 1/P1)−1.

If a part where the gradient changes (i.e., a point of the standard density Y0) is discontinuous in the compression table T0, an artifact might be produced in the processed image. Therefore, production of the artifact may be prevented by setting a function so that the gradient becomes continuous.

The compression processing unit 4 compresses the dynamic range of the image data set S0 in the following manner. The compression processing unit 4 calculates the density Y of each of the pixels in the image S0 by the aforementioned expression (1). Then, filtering processing is performed on the image S0 by using a low-pass filter in a predetermined size and an unsharp image having an unsharp density Y′ is obtained. Here, there are problems that if the size of the low-pass filter is too small, the sharpness is unnaturally emphasized and overshoot at edges becomes apparent. If a size of a major part of a subject, such as a face is small, an effect of the unsharp mask is not sufficiently realized. Further, the size of the apparatus becomes large because an operation amount increases. Therefore, in the present embodiment, the size of the low-pass filter is set so that the aforementioned problems will be prevented.

Next, the compression processing unit 4 performs dynamic range compression processing on the image data set S0 by using the compression table T0 created by the compression table creation unit 3. Specifically, each of a plurality of processed color components R1, G1 and B1 of RGB data is obtained by adding a value of LutDR(Y′) to each of the color components R0, G0 and B0 of RGB data of each of the pixels in the image S0 as shown in the following expressions (5)-(7). The value of LutDR(Y′) is obtained by processing an unsharp density Y′ of each of the pixels by using the compression table T0.
R1=R0+LutDR(Y′) (5)
G1=G0+LutDR(Y′) (6)
B1=B0+LutDR(Y′) (7)

Then, the compression processing unit 4 outputs a processed image data set S1 including each of the processed color components R1, G1 and B1 of the RGB data to the image output unit 5.

The image output unit 5 prints out the processed image data set S1 and obtains a print P of the processed image.

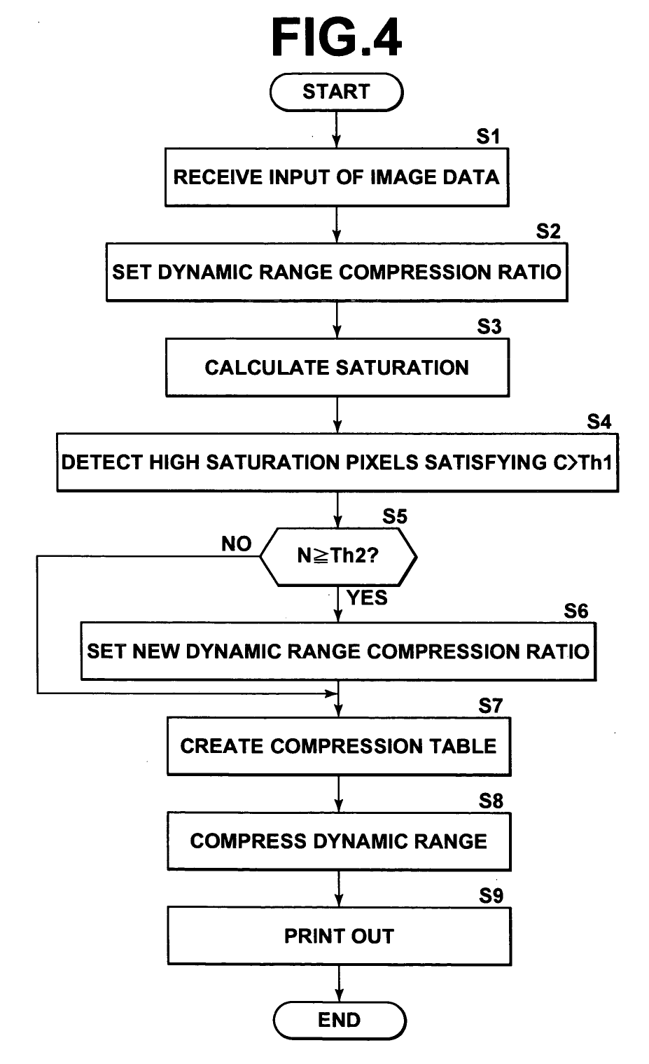

Next, an operation in the present embodiment will be described. FIG. 4 shows a flow chart of processing performed in the present embodiment. First, the image input unit 1 receives an input of the image data set S0 (step S1). Next, the image analysis unit 2 analyzes the image data set S0 and calculates a dynamic range compression rate P0 (step S2). Further, the image analysis unit 2 calculates saturation C of each of the pixels in the image S0 (step S3) and detects high saturation pixels of which saturation C is equal to or higher than a threshold value Th1 (step S4). The image analysis unit 2 judges whether a pixel number N of the high saturation pixels is equal to or larger than a threshold value Th2 (step S5). If step S5 is YES, the image analysis unit 2 sets a new dynamic range compression rate P1 by lowering the dynamic range compression rate P0 (step S6).

Next, the compression table creation unit 3 creates a compression table T0 based on the dynamic range compression rates P0 and P1 set by the image analysis unit 2 (step S7). Then, the compression processing unit 4 compresses the dynamic range of the image S0 by using the compression table T0 and obtains a processed image data set S1 (step S8). The image output unit 5 prints out the processed image data set S1 (step S9) and processing ends.

As described above, in the present embodiment, if the pixel number N of high saturation pixels, of which saturation C is higher than the threshold value Th1, is equal to or larger than the threshold value Th2, the new dynamic range compression rate P1 is set by lowering the dynamic range compression rate P0 which has already been set. Here, if the dynamic range compression rate is lowered, the degree of compressing the dynamic range of the image S0 is reduced. Accordingly, the high saturation pixels included in the image S0 become less saturated. Therefore, according to the present embodiment, a dynamic range of an image including particularly many high saturation pixels can be compressed while saturation of the high saturation pixels is prevented.

Further, in the aforementioned embodiment, the new dynamic range compression rate P1 which is lower than the dynamic range compression rate P0 is set by using the aforementioned expression (4). However, the new dynamic range compression rate P1 may also be set in the manner that the compression rate is lowered more as the pixel number N of the high saturation pixels becomes larger. In this case, the new dynamic range compression rate P1 may also be set so that the compression rate is gradually lowered according to the pixel number N of the high saturation pixels.

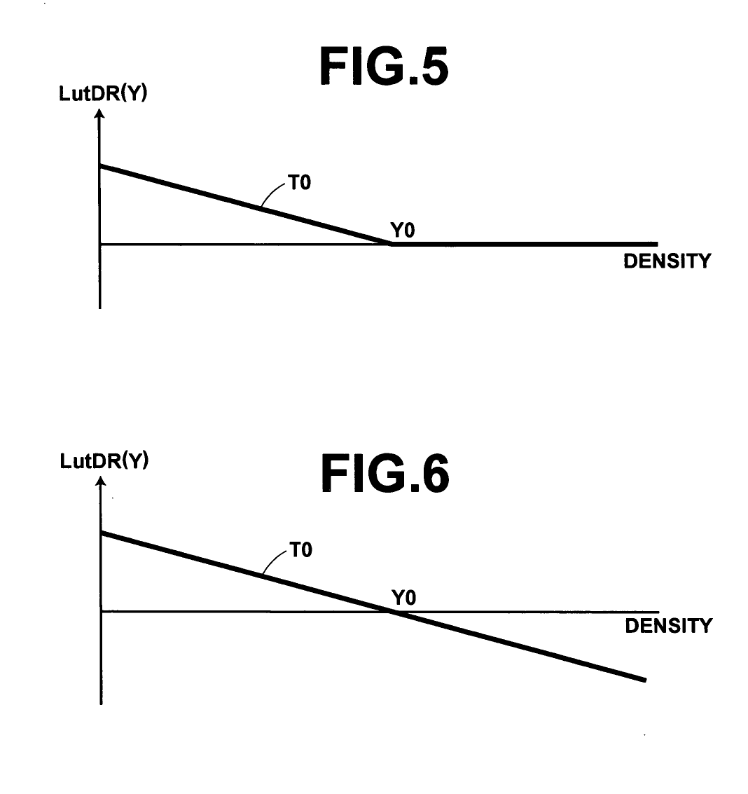

Further, in the aforementioned embodiment, the compression table T0 for compressing the dynamic range in a shadow side of the image S0 is created. However, a compression table T0 for compressing a dynamic range in a highlight side of the image S0, as illustrated in FIG. 5 and a compression table T0 for compressing the dynamic range in both shadow and highlight sides of the image S0, as illustrated in FIG. 6 may also be created.

Further, in the aforementioned embodiment, the compression processing unit 4 compresses the dynamic range of the image data set S0 by obtaining the unsharp image of the image S0, having the unsharp density Y′. However, the density Y before performing filtering processing by using the low-pass filter may be used instead of the unsharp density Y′. Each of the processed color components R1, G1 and B1 of the RGB data may also be obtained by adding a value of LutDR(Y) to each of the color components R0, G0 and B0 of the RGB data of each of the pixels in the image S0, as shown in the following expressions (8)-(10). The value of LutDR(Y) is obtained by processing the density Y of each of a plurality of pixels by using the compression table T0. Accordingly, dynamic range compression processing may be performed at a high speed.
R1=R0+LutDR(Y) (8)
G1=G0+LutDR(Y) (9)
B1=B0+LutDR(Y) (10)

1. An image processing apparatus comprising:
a dynamic range compression means for obtaining a processed image of which dynamic range has been compressed by compressing a dynamic range of a color image;
a compression rate setting means for setting a dynamic range compression rate for compressing the dynamic range of the color image based on the dynamic range of the color image;
a compression rate changing means for calculating saturation of each of pixels in the color image, counting a pixel number of high saturation pixels of which saturation is higher than a first threshold value, and if the pixel number is equal to or larger than a second threshold value, setting a new dynamic range compression rate which is lower than the dynamic range compression rate set by the compression rate setting means; and
a compression table creation means for creating a compression table based on one of the dynamic range compression rate and the new dynamic range compression rate.

2. An image processing apparatus as defined in claim 1, wherein the compression rate setting means creates a histogram of an image data set representing the color image, calculates a dynamic range of the color image based on the histogram, and sets a dynamic range compression rate for each of an area of relatively high data values, an area of relatively low data values and/or a whole area of the image data set based on the dynamic range by using a predetermined standard value of the image data set as a standard.

3. An image processing apparatus as defined in claim 1, wherein the compression rate changing means sets the new dynamic range compression rate by lowering the dynamic range compression rate set by the compression rate setting means by a predetermined value.

4. An image processing apparatus as defined in claim 1, wherein the compression rate changing means sets the new dynamic range compression rate by lowering the dynamic range compression rate set by the compression rate setting means more as the pixel number of the high saturation pixels becomes larger.

5. An image processing apparatus as defined in claim 4, wherein the compression rate changing means sets the new dynamic range compression rate so that the compression rate becomes gradually lower according to the pixel number of the high saturation pixels.

6. An image processing method comprising the steps of:
obtaining a processed image of which dynamic range has been compressed by compressing a dynamic range of a color image;
setting a dynamic range compression rate for compressing the dynamic range of the color image based on the dynamic range of the color image;
calculating saturation of each of a plurality of pixels in the color image, counting a pixel number of high saturation pixels of which saturation is higher than a first threshold value, and if the pixel number is equal to or larger than a second threshold value, setting a new dynamic range compression rate which is lower than the dynamic range compression rate; and
creating a compression table based on one of the dynamic range compression rate and the new dynamic range compression rate.

7. A program for causing a computer to execute an image processing method, the program comprising the procedures for:
obtaining a processed image of which dynamic range has been compressed by compressing a dynamic range of a color image;
setting a dynamic range compression rate for compressing the dynamic range of the color image based on the dynamic range of the color image;
calculating saturation of each of a plurality of pixels in the color image, counting a pixel number of high saturation pixels of which saturation is higher than a first threshold value, and if the pixel number is equal to or larger than a second threshold value, setting a new dynamic range compression rate which is lower than the dynamic range compression rate; and
creating a compression table based on one of the dynamic range compression rate and the new dynamic range compression rate.
